(19) United States
(12) Patent Application Publication
(10) Pub. No.: US 2004/0191410 A1
(43) Pub. Date: Sep. 30, 2004

(54) Fuel cell, method of manufacturing the same, electronic apparatus, and automobile

(75) Inventors: Katsuyuki Morii, Suwa-shi (JP); Hirokazu Komatsu, Yokosuka-shi (JP)

Correspondence Address: OLIFF & BERRIDGE, PLC, P.O. BOX 19928, ALEXANDRIA, VA, 22320, US

(73) Assignee: SEIKO EPSON CORPORTION, Tokyo (JP)

(21) Appl. No.: 10/791,722

(22) Filed: Mar. 4, 2004

(30) Foreign Application Priority Data
Mar. 31, 2003 (JP) 2003-095965

(51) Int. Cl. B05D 5/12; H01M 8/10

(52) U.S. Cl. 427/115; 429/30

(57) ABSTRACT

To provide a method to effectively manufacture a fuel cell having high output density and excellent cell characteristics, and an electronic apparatus and an automobile including the fuel cell as a power supply, the fuel cell including reaction layers with high reaction efficiency and current collecting layers to effectively collect electrons generated from the reaction layers. A method of manufacturing a fuel cell, which includes a first current collecting layer, a first reaction layer, an electrolyte membrane, a second reaction layer, and a second current collecting layer, and an electronic apparatus and an automobile, which include the fuel cell as a power supply, are provided, the manufacturing method including forming the first reaction layer by repeatedly applying a predetermined amount of reaction-layer-forming material on the first current collecting layer at predetermined intervals.

### BACKGROUND OF THE INVENTION

1. Field of Invention

The present invention relates to a fuel cell, which generates electricity by the reaction of different kinds of reaction gases supplied from the outside to respective electrodes, a method of manufacturing the same, and an electronic apparatus and an automobile provided with the fuel cell as a power supply.

2. Description of Related Art

In the related art, there exist fuel cells including an electrolyte membrane, an electrode (anode) disposed on one surface of the electrolyte membrane, and an electrode (cathode) disposed on the other surface of the electrolyte membrane. For example, in the case of a solid polymer electrolyte type fuel cell, which has a solid polymer electrolyte membrane as an electrolyte membrane, a reaction occurs at the anode whereby hydrogen is resolved into hydrogen ions and electrons, the electrons moving to the cathode and the hydrogen ions moving through the electrolyte membrane toward the cathode. At the cathode, a reaction takes place whereby water is generated from the oxygen gas, the hydrogen ions, and the electrons.

In such a solid polymer electrolyte type fuel cell, each of the electrodes usually include a reaction layer, which is composed of a gas reaction catalyst, i.e., metal particulates, a gas diffusion layer, which is composed of carbon particulates and formed on the substrate side of the reaction layer, and a current collecting layer, which is made of a conductive material and formed on the substrate side of the gas diffusion layer. At one substrate, the hydrogen gas, which has passed through a gap between the carbon particulates of the gas diffusion layer and has then been uniformly diffused, is subjected to reaction on the reaction layer and is then resolved into electrons and hydrogen ions. The electrons so produced are collected in the current collecting layer, so that the electrons flow toward a current collecting layer of a second substrate. The hydrogen ions move toward the reaction layer of the second substrate through the polymer electrolyte membrane, whereas the electrons reaching the current collecting layer react with the oxygen gas to generate water.

In such a fuel cell, methods of forming the reaction layer are known in the related art, which include, for instance: (a) a method of transcribing a catalyst layer (reaction layer) to an electrolyte membrane including preparing a paste to form an electrode catalyst layer by mixing catalyst-carrying carbon with a polymer electrolyte solution and an organic solvent, applying and drying the paste on a transcription substrate (polytetrafluoroethylene sheet), thermally pressing the transcription substrate against the electrolyte membrane, and peeling off the transcription substrate (see Japanese Unexamined Patent Application Publication No. 8-88008); and (b) a method of forming a reaction layer including applying an electrolyte solution, in which solid catalyst-carrying carbon particles are dispersed, on a carbon layer electrode using a sprayer, and subsequently allowing the solvent to volatilize (see Japanese Unexamined Patent Application Publication No. 2002-298860).

The aforementioned methods are problematic in that they require a lot of complicated steps, in which the properties (output density) of the resultant fuel cell deteriorate due to the difficulty encountered in uniformly applying the catalyst and in precisely applying a predetermined amount of catalyst to a given position, and in that the use of an increased amount of an expensive catalyst, such as platinum, leads to a high manufacturing cost.

### SUMMARY OF THE INVENTION

The present invention is designed to address the problems inherent in the prior art. The invention provides fuel cell manufacturing methods, electronic, apparatus and an automobile provided with the fuel cell as a power supply. The fuel cell manufacturing methods being capable of efficiently manufacturing a fuel cell which has high output density and enhanced properties and includes a reaction layer of enhanced reaction efficiency and a current collecting layer to collect electrons generated in the reaction layer.

The inventors have performed extensive research to develop a solution to the related art problems noted above and have finalized the present invention through discovery of the fact that a reaction layer having a uniform and predetermined amount of catalyst metal can be formed efficiently by repeatedly applying a given amount of reaction-layer-forming material at predetermined intervals using an inkjet discharging device (hereinafter, a “discharging device”).

According to a first aspect of the invention, there is provided a method of manufacturing a fuel cell including a first current collecting layer, a first reaction layer, an electrolyte membrane, a second reaction layer, and a second current collecting layer, the method including forming the first reaction layer by repeatedly applying a reaction-layer-forming material on the first current collecting layer at predetermined intervals.

Preferably, a manufacturing method according to an aspect of the present invention includes: on a first substrate, forming first gas passages to supply first reaction gas; forming a first current collecting layer to collect electrons, which are generated by the reaction of the first reaction gas supplied through the first gas passages; forming a first reaction layer to cause the first reaction gas supplied through the first gas passages to react with a catalyst; forming an electrolyte membrane; and on a second substrate, forming second gas passages to supply second reaction gas; forming a second current collecting layer to collect electrons, which are subjected to reaction with the second reaction gas supplied through the second gas passages; and forming a second reaction layer to cause the second reaction gas supplied through the second gas passages to react with a catalyst, at least one of forming the first reaction layer and the forming the second reaction layer forms the first reaction layer or the second reaction layer by repeatedly applying a predetermined amount of reaction-layer-forming material on the first or second current collecting layer at predetermined intervals.

In the manufacturing method of an aspect of the present invention, it is preferable that a discharging device be employed to apply the reaction-layer-forming material.

In the manufacturing method of an aspect of the present invention, it is preferable that the first reaction layer be formed by removing unnecessary components from the film obtained by applying the reaction-layer-forming material under reduced pressure and at a temperature no greater than 100° C.

Furthermore, in the manufacturing method of an aspect of the present invention, it is preferable that the first reaction layer be formed by repeating a unit operation in which a predetermined amount of reaction-layer-forming material is applied on the entire area of a first reaction layer forming region on the first current collecting layer at predetermined intervals and unnecessary components are removed from droplets of the applied reaction-layer-forming material. In addition, it is preferable that the discharging device having a plurality of discharging nozzles be used and the reaction-layer-forming material be discharged and applied during every unit operation by a different discharging nozzle.

According to a second aspect of the present invention, an electronic apparatus including, as a power supply, the fuel cell manufactured by the manufacturing method of an aspect of the present invention is provided.

According to a third aspect of the invention, an automobile including, as a power supply, the fuel cell manufactured by the manufacturing method of an aspect of the present invention is provided.

According to the fuel cell manufacturing method of an aspect of the present invention, it is possible to efficiently form a reaction layer having a uniform and predetermined amount of catalyst metal. Furthermore, in comparison with the related art in which a reaction-layer-forming material is applied on the entire surface of a reaction layer, the amount of catalyst metal used is reduced, and thus it is possible to provide a low-cost fuel cell.

In the fuel cell manufacturing method of an aspect of the present invention, the use of the discharging device to apply the reaction-layer-forming material assures that a predetermined amount of reaction-layer-forming material is precisely applied to a desired position. Thus, it is possible to more effectively form a reaction layer having a uniform and predetermined amount of catalyst metal.

In the manufacturing method of an aspect of the present invention, if the first reaction layer is formed by removing unnecessary components from the film obtained by applying the reaction-layer-forming material under reduced pressure and at a temperature no greater than 100° C., a reaction layer having a uniform and predetermined amount of catalyst metal can be more effectively formed without destroying the dispersion condition of the reaction-layer-forming material in the film formed by a discharging device.

In the manufacturing method of an aspect of the present invention, if the first reaction layer is formed by repeating a unit operation, in which a given amount of reaction-layer-forming material is applied on the entire area of a first reaction layer forming region on the first current collecting layer at predetermined intervals and unnecessary components are removed from droplets of the applied reaction-layer-forming material, a reaction layer having a uniform and predetermined amount of catalyst metal can be more effectively formed without destroying the dispersion condition of the reaction-layer-forming material in the film formed by a discharging device.

Furthermore, in the manufacturing method of the present invention, if the discharging device with a plurality of discharging nozzles is used and the reaction-layer-forming material is applied during every unit operation by a different discharging nozzle, a reaction layer having uniformly dispersed catalyst metal can be effectively formed since no variation in the amount of applied reaction-layer-forming material per unit area occurs.

The electronic apparatus according to an aspect of the present invention includes, as a power supply the fuel cell manufactured by a manufacturing method of an aspect of the present invention. This enables the power supply of the electronic apparatus to supply clean energy in consideration of the global environment.

In addition, an automobile according to an aspect of the present invention includes, as a power supply, the fuel cell manufactured by a manufacturing method of an aspect of the present invention. This enables the power supply of the automobile to supply clean energy in consideration of the global environment.

### BRIEF DESCRIPTION OF THE DRAWINGS

FIG. 1 is a schematic showing an example of the manufacturing line of a fuel cell according to an exemplary embodiment of the present invention;

FIG. 2 is a schematic showing an inkjet type discharging device according to an exemplary embodiment of the present invention;

FIG. 3 is a flow chart of a fuel cell manufacturing method according to an exemplary embodiment of the present invention;

FIGS. 4(A)-4(B) are schematics of a substrate in a manufacturing process of the fuel cell according to an exemplary embodiment of the present invention;

FIGS. 5(A)-5(B) are schematics illustrating a process of forming gas passages according to an exemplary embodiment of the present invention;

FIG. 6 is a cross-sectional view of a substrate in the manufacturing process of the fuel cell according to an exemplary embodiment of the present invention;

FIG. 7 is a cross-sectional view of a substrate in the manufacturing process of the fuel cell according to an exemplary embodiment of the present invention;

FIG. 8 is a cross-sectional view of a substrate in the manufacturing process of the fuel cell according to an exemplary embodiment of the present invention;

FIGS. 9(A)-9(C) are schematics illustrating a process of forming a reaction layer according to an exemplary embodiment of the present invention;

FIG. 10 is a cross-sectional view of a substrate in the manufacturing process of the fuel cell according to an exemplary embodiment of the present invention;

FIG. 11 is a cross-sectional view of a substrate in the manufacturing process of the fuel cell according to an exemplary embodiment of the present invention;

FIG. 12 is a cross-sectional view of a substrate in the manufacturing process of the fuel cell according to an exemplary embodiment of the present invention;

FIG. 13 is a cross-sectional view of a substrate in the manufacturing process of the fuel cell according to an exemplary embodiment of the present invention;

FIG. 14 is a cross-sectional view of a substrate in the manufacturing process of the fuel cell according to an exemplary embodiment of the present invention;

FIG. 15 is a cross-sectional view of a fuel cell according to an exemplary embodiment of the present invention; and

FIG. 16 is a schematic showing a large fuel cell obtained by stacking the fuel cell according to an exemplary embodiment of the present invention.

### DETAILED DESCRIPTION OF PREFERRED EMBODIMENTS

A method to manufacture a fuel cell according to an aspect of the present invention, and an electronic apparatus and an automobile with the fuel cell manufactured by a manufacturing method of an aspect of the present invention will now be described in detail.

An exemplary embodiment of the present invention relates to a method of manufacturing a fuel cell including a first current collecting layer, a first reaction layer, an electrolyte membrane, a second reaction layer, and a second current collecting layer, the method includes forming the first reaction layer by repeatedly applying a predetermined amount of reaction-layer-forming material on the first current collecting layer at predetermined intervals.

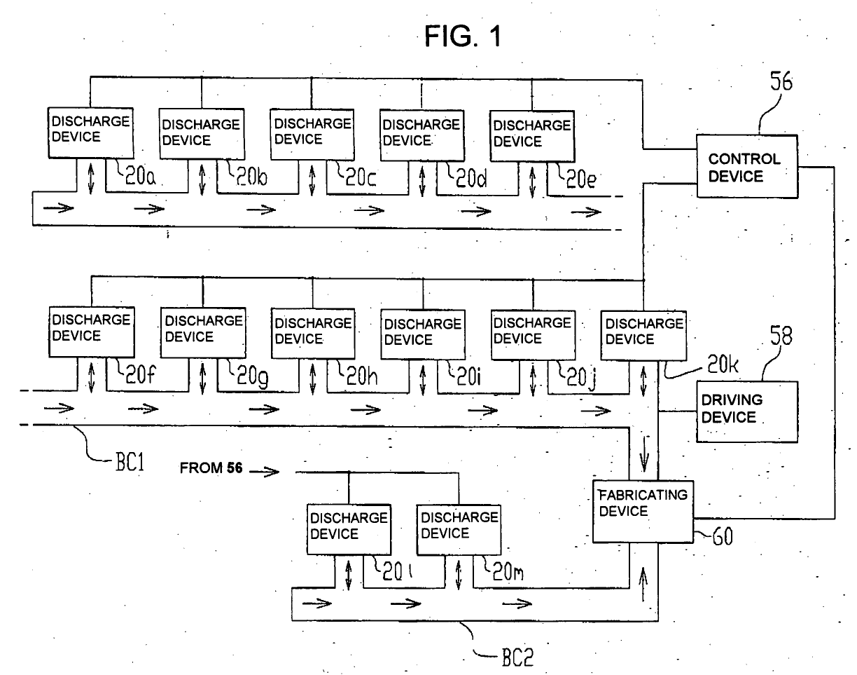

The method to manufacture the fuel cell according to an aspect of the present invention can be implemented with a fuel cell manufacturing apparatus (fuel cell manufacturing line) as shown in FIG. 1. The fuel cell manufacturing line shown in FIG. 1 includes discharging devices 20a to 20m, each of which is used in a respective process, a belt conveyor BC1 to connect the discharging devices 20a to 20k, a belt conveyor BC2 connecting the discharging devices 20l and 20m, a driving device 58 to drive the belt conveyors BC1 and BC2, a fabricating device 60 to fabricate the fuel cell, and a control device 56 to control the overall operation of the fuel cell manufacturing line.

The discharging devices 20a to 20k are arranged in line at predetermined intervals along the belt conveyor BC1, and the discharging devices 20l and 20m are arranged in line at predetermined intervals along the belt conveyor BC2. Further, the control device 56 is connected with the discharging devices 20a to 20k, the driving device 58, and the fabricating device 60.

In the fuel cell manufacturing line, the belt conveyor BC1 is driven by the driving device 58 to convey the substrate of the fuel cell (hereinafter, “substrate”) toward the discharging devices 20a to 20k, and then the fuel cell is processed by the discharging devices 20a to 20k. Similarly, the belt conveyor BC2 is driven by control signals from the control device 56 to convey the substrate toward the discharging devices 20l and 20m, and then the substrate is processed by the discharging devices 20l and 20m. Furthermore, the fabricating device 60 performs the fuel cell-fabricating operation using the substrate conveyed by the belt conveyors BC1 and BC2 on the basis of the control signals from the control device 56.

The discharging devices 20a to 20m are not restricted to a specific type, as long as an inkjet type discharging device is employed. For example, a thermal discharging device that discharges droplets with bubbles generated by thermal foaming and a piezo-type discharging device that discharges droplets by compression with a piezo-element can be employed.

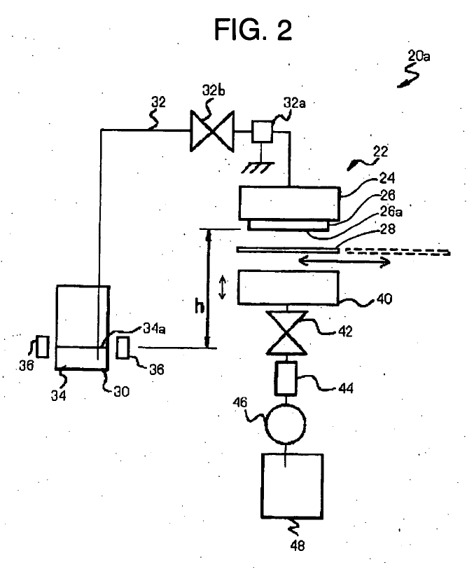

In the present exemplary embodiment, the device shown in FIG. 2 is employed as, the discharging device 20a. The discharging device 20a includes a tank 30 to contain a discharge material 34, an inkjet head 22 connected with the tank 30 through a discharge-material conveying pipe 32, a table 28 to load and convey the material to be discharged, a suction cap 40 to suck the discharge material 34 remaining in the inkjet head 22 to remove superfluous discharge material from the inkjet head 22, and a liquid waste tank 48 to contain the superfluous discharge material sucked by the suction cap 40.

The tank 30 contains a discharge material 34, such as a resist solution, and includes a level control sensor 36 to control the liquid level 34a of the discharge material contained in the tank 30. The level control sensor 36 carries out the control operation to maintain the difference h (hereinafter, referred to as a ‘head value’) between the front end 26a of a nozzle-forming surface 26 provided in the inkjet head 22 and the liquid level 34a in the tank 30 below a predetermined amount. For example, by controlling the liquid level 34a such that the head value becomes 25 m±0.5 mm, the discharge material 34 in the tank 30 can be sent to the inkjet head 22 at a predetermined pressure range. As the discharge material 34 is sent at a predetermined pressure range, the required amount of discharge material 34 can stably be discharged from the inkjet head 22.

The discharge-material conveying pipe 32 has a discharge material passage grounding connector 32a to prevent the discharge-material conveying pipe 32 from becoming electrically charged by flowing material therein and a head part bubble exhaust valve 32b. The head part bubble exhaust valve 32b is used when the discharge material in the inkjet head 22 is sucked by the suction cap 40 to be described later.

The inkjet head 22 has a head body 24 and the nozzle-forming surface 26 provided with a plurality of nozzles to discharge the discharge material, and the discharge material, for example, a resist solution, which is applied on the substrate when gas passages to provide reaction gas are formed on the substrate, is discharged from nozzles in the nozzle-forming surface 26.

The table 28 can be moved in a predetermined direction. The table 28 is moved in a direction designated by an arrow in FIG. 1, so that it can load the substrate conveyed by the belt conveyer BC1 and then enter the discharging device 20a.

The suction cap 40 is movable in the direction designated by an arrow in FIG. 2, makes close contact with the nozzle-forming surface 26 so as to surround the plurality of nozzles formed on the nozzle-forming surface 26, and forms an airtight space with the nozzle-forming surface 26 to exclude outside air from the nozzles. In other words, when the suction cap 40 sucks the discharge material from the inkjet head 22, the discharge material is sucked by the suction cap 40 in a state where the head part bubble exhaust valve 32b is closed and then the inflow of the discharge material from the tank 30 is blocked. Thus, the flowing speed of the sucked discharge material increases to rapidly discharge bubbles from the inkjet head 22.

A passage is provided under the suction cap 40, and a suction valve 42 is provided on the passage. The suction valve 42 functions to maintain the passage in a closed state for the purpose of shortening the time to balance the pressure (atmosphere pressure) between the lower side of the suction valve 42 and the upper side thereof, that is, the inkjet head 22. A suction pump 46 including a tube pump and the like, and a suction pressure-detecting sensor 44 to detect abnormal suction of the discharge material are disposed on the passage. Furthermore, the discharge material 34 sucked and conveyed by the suction pump 46 is contained temporarily in the liquid waste tank 48.

In the present exemplary embodiment, the constitution of the discharging devices 20b to 20m is the same as that of the discharging device 20a except that the kind of the discharge material 34 is different. Therefore, corresponding components in the respective discharging devices are referred to with the same reference numerals.

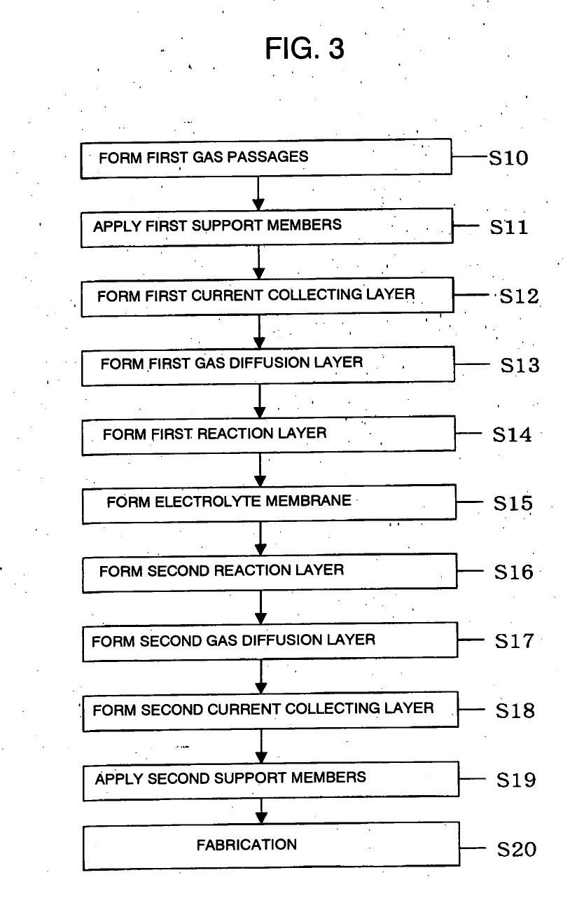

Next, the respective processes for manufacturing a fuel cell are described with a fuel cell manufacturing line shown in FIG. 1. FIG. 3 is a flow chart showing a method of manufacturing the fuel cell with the fuel cell manufacturing line shown in FIG. 1.

As shown in FIG. 3, a method of manufacturing a fuel cell according to the present exemplary embodiment include: forming gas passages on a first substrate (S10 a first gas passage forming step); applying first support members into the gas passages (S11, a first support member applying step); forming a first current collecting layer (S12, a first current collecting layer forming step); forming a first gas diffusion layer (S13, a first gas diffusion layer forming step); forming a first reaction layer (S14, a first reaction layer forming step); forming an electrolyte membrane (S15, an electrolyte membrane forming step); forming a second reaction layer (S16, a second reaction layer forming step); forming a second gas diffusion layer (S17, a second gas diffusion layer forming step); forming a second current collecting layer (S18, a second current collecting layer forming step); applying second support members into the second gas passages (S19, a second support member applying step); and stacking the second substrate having the second gas passages formed thereon (S20, a fabricating step).

(1) First Gas Passage Forming Step (S10)

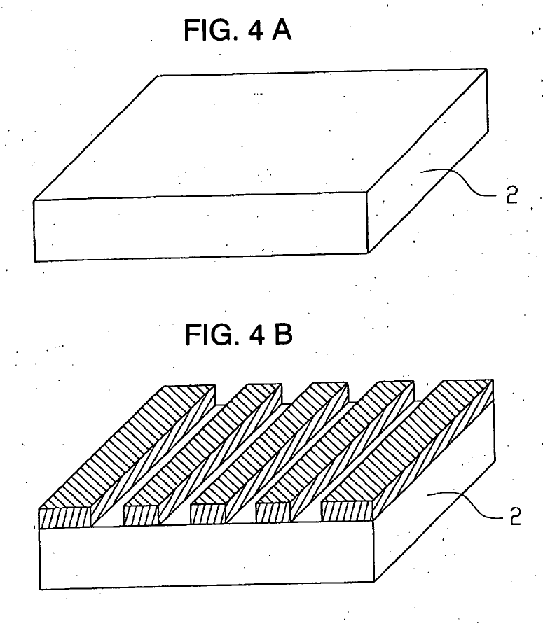

First, as shown in FIG. 4(A), a first substrate 2 of a rectangular shape is prepared, and the substrate 2 is conveyed toward the discharging device 20a by the belt conveyor BC1. The substrate 2 is not restricted to a specific type, and a silicon substrate, etc., used in a general fuel cell may be employed. A silicon substrate is used in the present exemplary embodiment.

The substrate 2 conveyed by the belt conveyor BC1 enters the discharging device 20a while being loaded on the table 28 of the discharging device 20a. In the discharging device 20a, a resist solution contained in the tank 30 of the discharging device 20a is applied on a predetermined position of the substrate 2 loaded on the table 28 through the nozzles in the nozzle-forming surface 26, and then a resist pattern (oblique lines shown in FIG. 4(A)) is formed on the surface of the substrate 2. As shown in FIG. 4(B), the resist pattern is formed on portions other than the portions of the surface of the substrate 2 on which the first gas passages to supply the first reaction gas are formed.

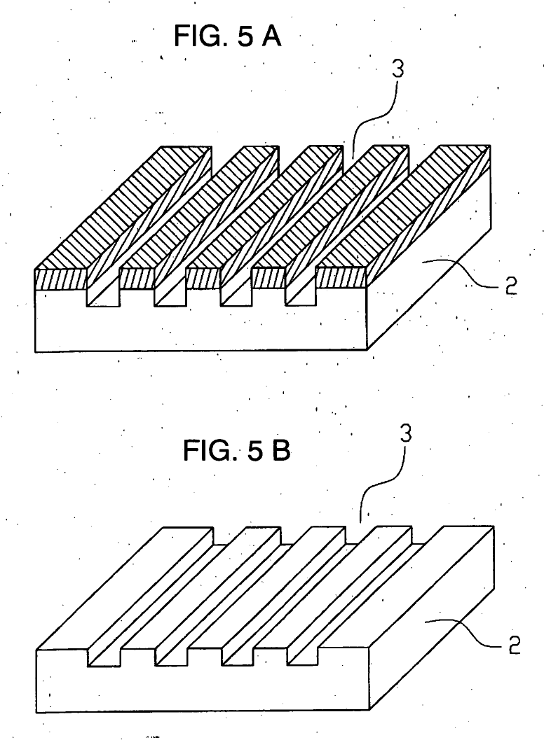

The substrate 2, on which the resist pattern is formed on the predetermined portions thereof, is then conveyed toward the discharging device 20b by the belt conveyor BC1 and enters the discharging device 20b while being loaded on the table 28 of the discharging device 20b. In the discharging device 20b, an etching solution, such as an aqueous solution of hydrofluoric acid, contained in the tank 30 is applied on the surface of the substrate 2 through the nozzles of the nozzle-forming surface 26. The portion of the surface of the substrate 2 other than the part having the resist pattern formed thereon is etched by the etching solution, and first gas passages, the cross-section of which is in a “U” shape extending from one side to the other side of the substrate 2, are formed as shown in FIG. 5(A). Further, as shown in FIG. 5(B), the resist pattern on the substrate having the gas passages formed thereon is removed by cleaning the surface thereof using a cleaning device (not shown). Subsequently, the substrates 2 having the gas passages formed thereon is transferred from the table 28 to the belt conveyor BC1 and is then conveyed to the discharging device 20c by the belt conveyor BC1.

(2) First Support Member Applying Step (S11).

Next, the first support members to support the first current collecting layer are applied into the first gas passages formed on the substrate 2. The first support members are applied by loading the substrate 2 on the table 28, moving the substrate 2 into the discharging device 20c, and then discharging the first support members 4 contained in the tank 30 into the first gas passages formed on the substrate 2 through the nozzles on the nozzle-forming surface 26 by the discharging device 20c.

The first support members are not restricted to a specific type, but may be any type that is inactive with respect to the first reaction gas, that prevents the first current collecting layer from falling into the first gas passage, and that does not hinder the first reaction gas from being diffused to the first reaction layer. For example, the first support members include carbon particles, glass particles, and the like. In the present exemplary embodiment, porous carbon, which is 1 to 5 μm in diameter, is used. Since porous carbon of a predetermined particle size is used as the support members, the flow of the reaction gas is not hindered since the reaction gas supplied through the gas passages is diffused upward from the gaps in the porous carbon.

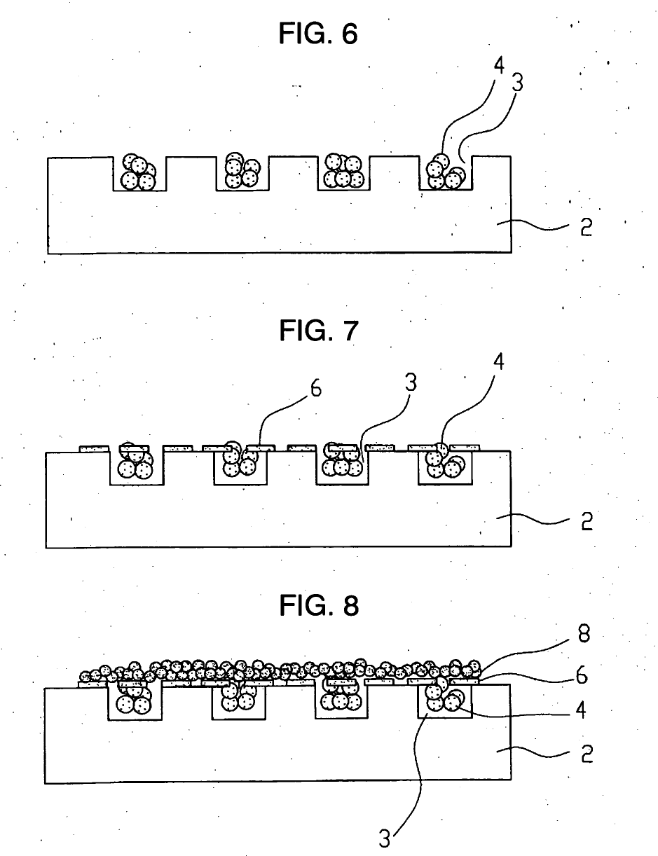

FIG. 6 is a cross-sectional view of the substrate 2 having the first support members 4 applied thereto. The substrate 2 having the first support members 4 applied thereto is transferred from the table 28 to the belt conveyor BC1 and is then conveyed to the discharging device 20d by the belt conveyor BC1.

(3) First Current Collecting Layer Forming Step (S12)

Next, the first current collecting layer to collect electrons generated by the reaction of the first reaction gas is formed on the substrate 2. First, the substrate 2 conveyed to the discharging device 20d by the belt conveyor BC1 is loaded onto the table 28 and is then sent to the discharging device 20d. In the discharging device 20d, a certain amount of current collecting layer forming material contained in the tank 30 is discharged onto the substrate 2 through the nozzles in the nozzle-forming surface 26 to form the first current collecting layer with a predetermined pattern.

The current collecting layer forming material is not restricted to a specific type, but may be any type as long as the material includes a conductive material. For example, the conductive material may include copper, silver, gold, platinum, aluminum, and the like. One kind of material or a combination of two or more kinds of materials can be used. The current collecting layer forming material can be manufactured by dispersing at least one of these conductive materials in an appropriate solvent and by adding a certain dispersing agent, if required.

In the present exemplary embodiment, since the current collecting layer forming material can be applied by the discharging device 20d, a predetermined amount of material can be applied exactly on a predetermined region through a simple operation. Therefore, the amount of current collecting layer forming material consumed is greatly reduced, and the desired pattern (form) of the current collecting layer can be formed efficiently. Thus, the air-permeability of the reaction gas can be easily controlled by changing the application intervals of the current collecting layer forming material in consideration of the position, and it is easy to change the kind of the current collecting layer forming material in consideration of the applying position.

FIG. 7 is a cross-sectional view of the substrate 2 having the first current collecting layer 6 formed thereon. As shown in FIG. 7, the first current collecting layer 6 is supported by the first support members 4 in the first gas passages, which are formed on the substrate 2, and do not fall into the first gas passages. The substrate 2 having the first current collecting layer 6 formed thereon is transferred from the table 28 to the belt conveyor BC1 and is then conveyed to the discharging device 20e by the belt conveyor BC1.

(4) First Gas Diffusion Layer Forming Step (S13)

Next, the first gas diffusion layer is formed on the current collecting layer on the substrate 2. First, the substrate 2 conveyed into the discharging device 20e by the belt conveyor BC1 is loaded on the table 28 and is transferred into the discharging device 20e. In the discharging device 20e, the first gas diffusion layer is formed by discharging the gas diffusion layer forming material contained in the tank 30 in the discharging device 20e onto predetermined regions on the surface of the substrate 2, which is loaded on the table 28, through the nozzles of the nozzle-forming surface 26.

Carbon particles are generally used as the gas diffusion layer forming material, however, carbon nanotubes, carbon nanophons, fullerenes, etc. can be used. In the present exemplary embodiment, since the gas diffusion layer is formed by the discharging device 20e, it is possible that, for example, the application intervals can be greater (several tens of micrometers) at the current collecting layer and smaller (several tens of nanometers) at the surface thereof. Thus, the gas diffusion layer with a passage width at an area near the substrate great enough to reduce the diffusion resistance of the reaction gas as much as possible and with uniform, narrow passages at an area near the reaction layer (at the surface of the gas diffusion layer) can be formed easily. Further, carbon particles are used on the substrate side of the gas diffusion layer, which can provide superior catalyst carrying ability even though the diffusion capacity thereof is low at the surface thereof.

FIG. 8 is a cross-sectional view of the substrate 2 having the first gas diffusion layer 8 formed thereon. As shown in FIG. 8, the first gas diffusion layer 8 is formed on the entire surface of the substrate 2 so as to cover the first current collecting layer formed on the substrate 2. The substrate 2 having the first gas diffusion layer 8 formed thereon is transferred from the table 28 to the belt conveyor BC1 and is conveyed toward the discharging device 20f by the belt conveyer BC1.

(5) First Reaction Layer Forming Step (S14)

Next, the first reaction layer is formed on the substrate 2. The first reaction layer is formed so as to electrically connect with the first current collecting layer through the gas diffusion layer 8.

First, the substrate 2 conveyed toward the discharging device 20f by the belt conveyer BC1 is loaded on the table 28 and then is transferred into the discharging device 20f. Then, a predetermined amount of reaction-layer-forming material contained in the tank 30 of the discharging device 20f is discharged at predetermined intervals on the portions of the surface of the substrate 2 where the first reaction layer is formed to form a film of the reaction-layer-forming material. Next, the reaction layer is formed by removing unnecessary parts from the film.

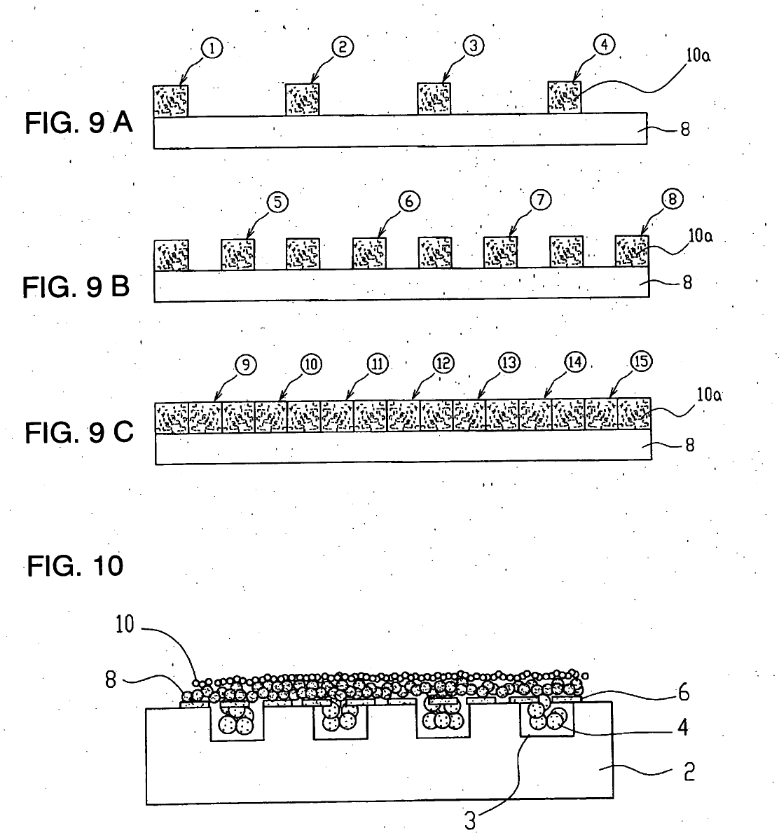

FIG. 9 is a view showing the concept of a process in which the film of the reaction-layer-forming material is formed by discharging a predetermined amount of reaction-layer-forming material on the first reaction layer forming region above the surface of the first current collecting layer 8 at predetermined intervals using the discharging device 20f. That is, as shown in FIG. 9(A), the reaction-layer-forming material is applied at equal intervals (that is, so as not to overlap with the previously applied droplets of the reaction-layer-forming material) on the entire first reaction layer forming region on the substrate. Then, as shown in FIG. 9(B), the reaction-layer-forming material is applied into the gaps therebetween at equal intervals. Furthermore, as shown in FIG. 9(C), the reaction-layer-forming material is applied into the gaps therebetween at equal intervals. By repeating such operation, the uniform application on the entire area can be achieved, and a uniform reaction layer of the desired amount of catalyst metal can be formed. Furthermore, in FIGS. 9(A) to 9(C), the circled numbers designate the applying order, and the reference numeral 10a designates the film of the reaction-layer-forming material.

The aforementioned method is similar to a case where, when tea leaves are put into a teapot containing boiled water and the tea is poured out into a plurality of teacups, the tea is repeatedly poured out into the plurality of teacups in a small quantity every time, which leads to the result that tea of uniform density can be achieved. In other words, since there is a difference in the amount or the density of the reaction-layer-forming material discharged at a time from the discharging device, in order to achieve a reaction layer that is uniformly applied and has a desired amount of catalyst metal, it is better to repeat the application of the reaction-layer-forming material at predetermined intervals than to apply it from one side to the other in order.

The size of the droplets and the applying intervals thereof are not restricted to a specific value, but may vary as long as they are so determined that the droplets do not make contact with each other while the droplets are applied. However, from the viewpoint of efficiently forming a reaction layer with the desired amount of catalyst metal, it is preferable that the size of the droplets be small (for example, below ten picoliters), and the applying interval be large (for example, 0.1 to 1 mm).

Examples of the reaction-layer-forming material are (a) a dispersion solution of metal-carrying carbon obtained by allowing a carbon carrier to adsorb a metal compound (for example, a metal complex and metal salt) or metal hydroxide, and (b) a dispersion solution of carbon carrier having metal particles adsorbed therein.

The aforementioned dispersion solution (a) can be manufactured as follows. First, a metal hydroxide is produced by adding a required alkali into an aqueous solution of a metal compound or a mixture of water and alcohol, and a carbon carrier, such as carbon black is added to the metal hydroxide and then is stirred while heating, thereby achieving a crude product of the metal carrying carbon by the adsorption (deposition) of the metal compound or metal hydroxide to the carbon carrier. Then, the obtained crude product is refined by repeatedly filtering, washing and drying, and a dispersion solution is achieved by dispersing the refined product into water or a mixture of water and alcohol. Furthermore, the aforementioned dispersion solution (b) can be manufactured by dispersing the metal particles into an organic dispersing agent and then by adding the carbon carrier. The organic dispersing agent used is not restricted to a specific material as long as metal particles can be uniformly dispersed into the dispersion solution. For example, alcohol, ketones, esters, ethers, hydrocarbons, aromatic hydrocarbons, and the like can be used.

Examples of metal used for the metal compound, the metal hydroxide, or the metal particles used for the aforementioned dispersion solutions (a) and (b) are one or more metal particles selected from the group including platinum, rhodium, ruthenium, iridium, palladium, or osmium, and alloys made of one or more of these, and platinum is especially preferable.

The first reaction layer 10, in which metal particles are carried on single coarse particles, can be achieved by forming the film of the reaction-layer-forming-material formed with the reaction-layer-forming material applied by the discharging device 20f and then by removing unnecessary components from the film.

Examples of a method to remove unnecessary components from the film composed of the reaction-layer-forming material include a method to remove unnecessary components by heating the film under a normal pressure in an inert gas atmosphere, and a method to remove unnecessary components by heating under reduced pressure, the latter being preferable. The heating temperature is preferably low, and more preferably, is not higher than 100° C., and still more preferably, not higher than 50° C. The process to remove the unnecessary components is preferably performed in a short period of time. If the removal process is performed over a long period of time at a high temperature, the metal particles manufactured by the discharging device (or fine particles of a metal compound) are not maintained in a uniformly-dispersed state, so a reaction layer in which the catalyst metal is dispersed uniformly cannot be achieved.

In an aspect of the present invention, the first reaction layer is preferably formed by repeating a unit operation in which the given amount of reaction-layer-forming material is applied on the entire area of the first reaction layer forming region at predetermined intervals and unnecessary components are removed from the droplets of the applied reaction-layer-forming material. Furthermore, it is preferable that the discharging device 20f with a plurality of discharging nozzles be used and the reaction-layer-forming material be discharged and applied during every unit operation by a different discharging nozzle. This is because the amount of catalyst metal applied on a unit area becomes uniform and a reaction layer with more uniformly dispersed catalyst metal can be formed.

FIG. 10 shows a cross section of the substrate 2 having the first reaction layer 10 formed thereon according to the above-mentioned process. The substrate 2 with the first reaction layer 10 is moved from the table 28 to the belt conveyor BC1 and is conveyed to the discharging device 20g by the belt conveyor BC1.

(6) Electrolyte Membrane Forming Step (S15).

Next, an electrolyte membrane is formed on the substrate 2 having the first reaction layer 10 formed thereon. First, the substrate 2 conveyed to the discharging device 20g by the belt conveyor BC1 is moved into the discharging device 20g while being loaded on the table 28. In the discharging device 20g, the electrolyte membrane 12 is formed by discharging the electrolyte membrane forming material contained in the tank 30 onto the first reaction layer 10 through the nozzles in the nozzle-forming surface 26.

Examples of the electrolyte membrane forming material include a polymer electrolyte material achieved by the micellation of perfluorosulfonic acid, such as NAFION (manufactured by E. I. Dupont) in a mixture of water and methanol at a weight ratio of 1:1, or ceramic-based solid electrolyte, such as tungstophosphoric acid, molybdophosphoric acid, and the like regulated to a predetermined viscosity (for example, 20 cP or less),.

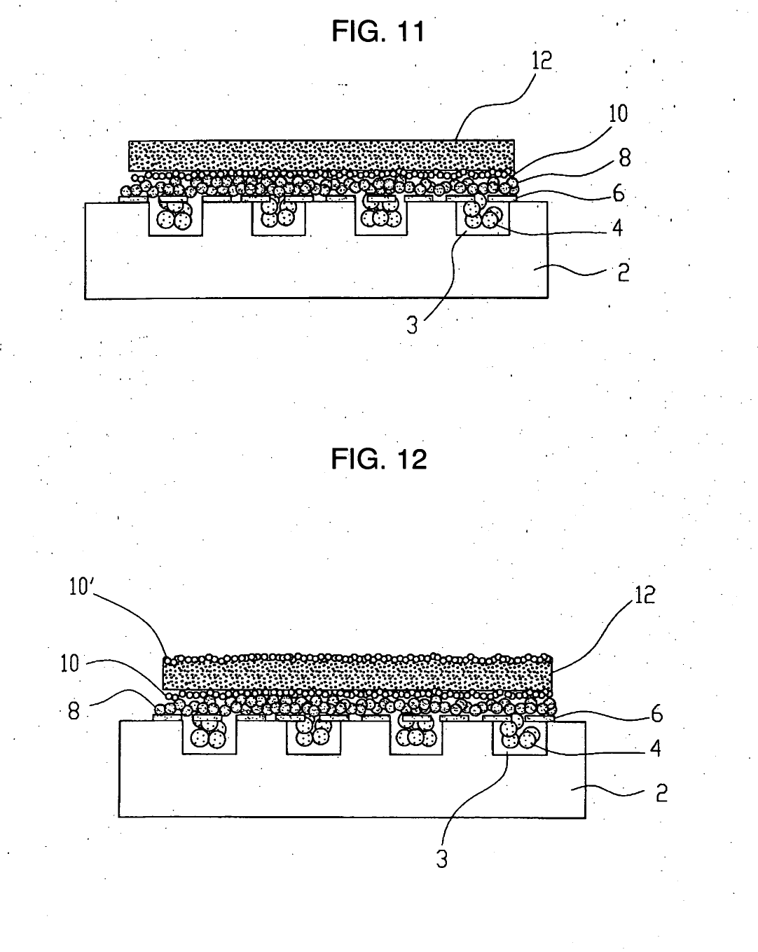

FIG. 11 shows a cross-sectional view of the substrate 2 having the electrolyte membrane formed thereon. As shown in FIG. 11, the electrolyte membrane 12 is formed to a predetermined thickness on the first reaction layer 10. The substrate 2 having the electrolyte membrane 12 formed thereon is transferred from the table 28 to the belt conveyor BC1 and is then conveyed to the discharging device 20h by the belt conveyor BC1.

(7) Second Reaction Layer Forming Step (S16)

Next, the second reaction layer is formed on the substrate 2 having the electrolyte membrane 12 formed thereon. The second reaction layer is formed by applying the reaction-layer-forming material on the substrate, on which the gas passages and the gas diffusion layer are formed, while inert gas is flowing through the gas passages.

First, the substrate 2 conveyed to the discharging device 20h by the belt conveyor BC1 is moved into the discharging device 20h while being loaded on the table 28. In the discharging device 20h, the second reaction layer 10′ is formed by the same process as that performed in the discharging device 20f. A material for forming the second reaction layer 10′ can be identical to that used for the first reaction layer.

FIG. 12 shows a cross-sectional view of the substrate 2 having the second reaction layer 10′ formed on the electrolyte membrane 12. As shown in FIG. 12, the second reaction layer 10′ is formed on the electrolyte membrane 12. The reaction of the second reaction gas is performed in the second reaction layer 10′. The substrate 2 having the second reaction layer 10′ formed thereon is moved from the table 28 to the belt conveyor BC1 and is then conveyed to the discharging device 20i by the belt conveyor BC1.

(8) Second Gas Diffusion Layer Forming Step (S17)

Next, a second gas diffusion layer is formed on the substrate 2 having the second reaction layer 10′ formed thereon. First, the substrate 2 conveyed to the belt discharging device 20i by the belt conveyor BC1 is moved into the discharging device 20i while being loaded on the table 28. In the discharging device 20i, the second gas diffusion layer 8′ is formed by the same process as that performed in the discharging device 20e. The second gas diffusion layer forming material can be identical to that used for the first gas diffusion layer 8.

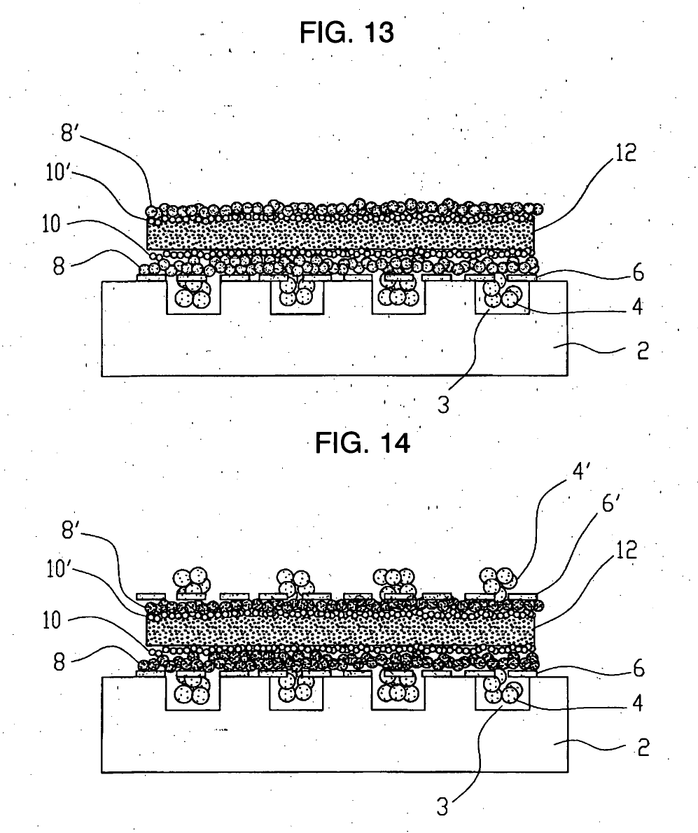

FIG. 13 shows a cross-sectional view of the substrate 2 having the second gas diffusion layer 8′ formed thereon. The substrate 2 having the second gas diffusion layer 8′ formed thereon is moved from the table 28 to the belt conveyor BC1 and is then conveyed to the discharging device 20j by the belt conveyor BC1.

(9) Second Current Collecting Layer Forming Step (S18)

Next, the second current collecting layer is formed on the substrate 2 having the second gas diffusion layer 8′ formed thereon. First, the substrate 2 conveyed to the discharging device 20j by the belt conveyor BC1 is moved into the discharging device 20j while being loaded on the table 28, and the second current collecting layer 6′ is formed on the second gas diffusion layer 8′ by the same process as that performed in the discharging device 20d. The material used for the second current collecting layer can be identical to that used for the first current collecting layer. The substrate 2 having the second current collecting layer 6′ formed thereon is moved from the table 28 to the belt conveyor BC1, and is conveyed to the discharging device 20k by the belt conveyor BC1.

(10) Second Support Member Applying Step (S19)

Next, the substrate 2 conveyed toward the discharging device 20k by the belt conveyor BC1 is moved into the discharging device 20k while being loaded on the table 28, and the second support members are applied by the same process as that performed by the discharging device 20c. The material for the second support members can be identical to that for the first support members.

FIG. 14 shows a cross-sectional view of the substrate 2 having the second current collecting layer 6′ and the second support members 4′ applied thereto. The second support members 4′ are formed on the second current collecting layer 6′ and are applied to the positions accommodated in the second gas passages that are formed on the second substrate stacked on the substrate 2.

(11) Second Substrate Fabricating Step (S20)

Next, the substrate 2 having the second support members 4′ applied thereto and the second substrate, on which the separate second gas passages are formed, are laminated. The laminating of the second substrate on the substrate 2, (the first substrate) is performed such that the second support members 4′ formed on the substrate 2 are accommodated in the second gas passages formed in the second substrate. In this situation, the second substrate can be made of the same material as that of the first substrate. Furthermore, the second gas passages are formed in the discharging devices 20l and 20m by the same process as that performed in the discharging devices 20a and 20b.

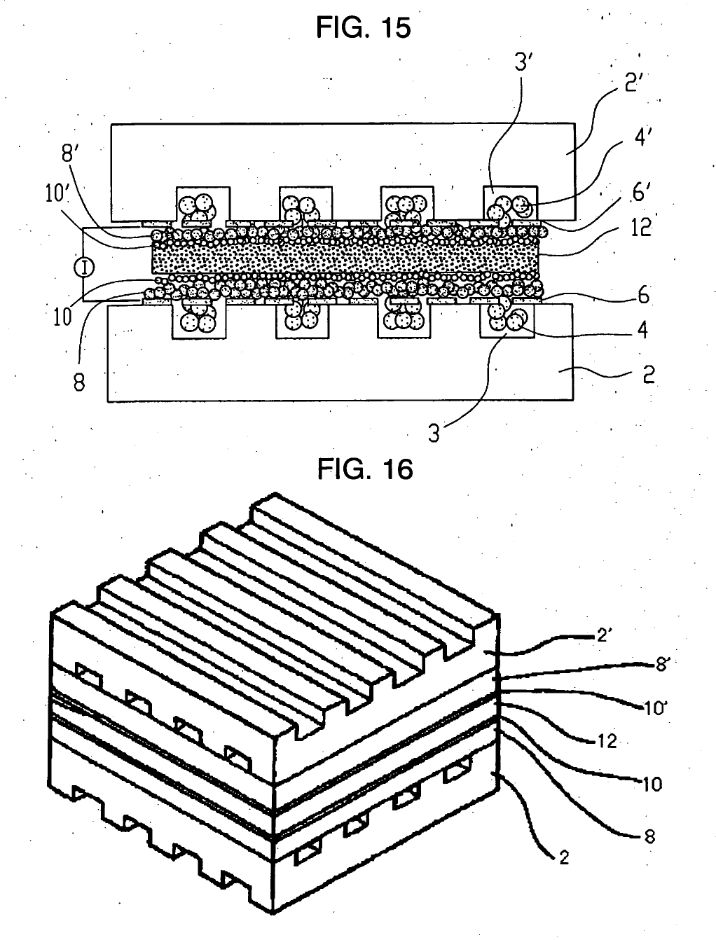

According to the above-mentioned processes, the fuel cell having the construction shown in FIG. 15 can be manufactured. The fuel cell shown in FIG. 15 includes, from the lower part thereof, the first substrate 2, the first gas, passages 3 formed on the first substrate 2, the first support members 4 accommodated in the first gas passages 3, the first current collecting layer 6 formed on the first substrate 2 and the first support members 4, the first gas diffusion layer 8, the first reaction layer 10 formed on the first gas diffusion layer 8, the electrolyte membrane 12, the second reaction layer 10′, the second gas diffusion layer 8′, the second current collecting layer 6′, the second gas passages 3′, the second support members 4′ accommodated in the second gas passages 3′, and the second substrate 2′. Furthermore, in the fuel cell shown in FIG. 15, the substrate 2′ is disposed such that the first gas passages, which have a “U” shape and extend from one side of the substrate 2′ to the other side thereof, are parallel to the second gas passages formed on the substrate 2′.

The fuel cell manufactured by the present exemplary embodiment is not restricted to a specific type. For example, other examples include a polymer electrolyte type fuel cell, a phosphoric acid type fuel cell, a direct methanol type fuel cell, and the like.

The fuel cell manufactured by the present exemplary embodiment operates as follows. That is, the first reaction gas is introduced through the first gas passages 3 of the first substrate 2 and is uniformly diffused by the gas diffusion layer 8. Then, the diffused first reaction gas reacts in the first reaction layer 10 to generate ions and electrons, and then the generated electrons are collected in the current collecting layer 8 and flow into the second current collecting layer 6′ of the second substrate 2′. In addition, the ions generated by the first reaction gas move to the second reaction layer 8′ through the electrolyte membrane 12. Meanwhile, the second reaction gas is introduced through the second gas passages 3′ of the second substrate 2′ and is then uniformly diffused by the second gas diffusion layer 8′. Then, the diffused second reaction gas reacts with the ions, which pass through the electrolyte membrane 12, and the electrons, which are transferred from the second current collecting layer 6′, in the second reaction layer 10′. For example, when the first reaction gas is hydrogen gas and the second reaction gas is oxygen gas, the reaction H₂→2H⁺+2e⁻ occurs in the first reaction layer 10, and the reaction 1/2O₂+2H⁺+2e⁻→H₂O takes place in the second reaction layer 10′.

In the method to manufacture the fuel cell according to the above-mentioned exemplary embodiment, the discharging devices are used in all of the processes, but the discharging devices can be used in any process for manufacturing the fuel cell. For example, the first current collecting layer and/or the second current collecting layer can be formed by applying the current collecting layer forming material using the discharging devices, and the same processes as the related art can be performed in other processes of the fuel cell manufacturing processes. Even in such a case, since the current collecting layer can be formed without using MEMS (Micro Electro Mechanical Systems), the manufacturing cost for the fuel cell can be lowered.

In the manufacturing method according to the exemplary embodiment as mentioned above, the gas passages are formed by forming a resist pattern on the substrate and then by etching it using an aqueous solution of hydrofluoric acid. However, the gas passages can be formed without forming the resist pattern. Furthermore, the gas passages may be formed by loading the substrate and discharging water on a predetermined region of the substrate under a fluorine gas atmosphere. Moreover, the gas passages may be formed by applying the gas passage forming material onto the substrate using a discharging device.

In the manufacturing method according to the exemplary embodiment as mentioned above, first, the elements of the fuel cell are formed on the first substrate supplied with the first reaction gas, and then the fuel cell is manufactured by laminating the second substrate thereon. However, the manufacture of the fuel cell can start from the substrate to which the second reaction gas is supplied.

In the manufacturing method according to the exemplary embodiment as mentioned above, the second support members are applied along the first gas passages formed on the first substrate. However, the second support members can be applied in a direction perpendicular to the first gas passages. That is, for example, it is possible that the second support members are applied so as to cross the gas passages formed on the first substrate at a right angle, for example, in a direction that extends from the right side of FIG. 5(B) to the left side thereof. In such a case, a fuel cell having a construction in which the first gas passages formed on the first substrate and the second gas passages formed on the second substrate are perpendicular to each other can be achieved.

In the manufacturing method according to the exemplary embodiment as mentioned above, the first current collecting layer, the first reaction layer, the electrolyte membrane, the second reaction layer, and the second current collecting layer are formed in the named order on the first substrate having the first gas passages formed thereon. However, first, the current collecting layer, the reaction layer, and the electrolyte membrane may be formed on the first substrate and the second substrate, respectively, and then the first substrate and the second substrate may be bonded to each other to manufacture the fuel cell.

In the fuel cell manufacturing line according to the present exemplary embodiment, the first manufacturing line for processing the first substrate and the second manufacturing line for processing the second substrate can be provided, and the processes in the respective manufacturing lines are performed in parallel. Thus, processes on the first substrate and processes on the second substrate can be performed in parallel, thereby manufacturing the fuel cell at high speed can be attained.

An electronic apparatus according to an aspect of the present invention includes the aforementioned fuel cell as a power supply. Examples of the electronic apparatus include mobile phones, PHSs, notebook-size personal computers, PDAs (personal digital assistants), mobile picture phone devices, and the like. Furthermore, the electronic apparatus of an aspect of the present invention can include some other functions, such as a game function, a data communication function, a recording and playback function, a dictionary function, and the like.

The electronic apparatus of an aspect of the present invention can include a power supply capable of supplying clean energy beneficial to the global environment.

An automobile of an aspect of the present invention includes the fuel cell as described above as a power supply. According to the manufacturing method of an aspect of the present invention, a large fuel cell can be manufactured by stacking a plurality of fuel cells. In other words, as shown in FIG. 16, a large fuel cell can be manufactured by forming other gas passages on the back side of the substrate 2′ of the manufactured fuel cell, by forming a gas diffusion layer, a reaction layer, and a electrolyte membrane on the back side of the substrate 2′, on which the gas passages are formed, using the same manufacturing process as the above-mentioned fuel cell manufacturing method and by stacking the fuel cells.

An automobile of an aspect of the present invention can include a power supply capable of supplying clean energy beneficial to the global environment.

What is claimed is:

1. A method of manufacturing a fuel cell including a first current collecting layer, a first reaction layer,.an electrolyte membrane, a second reaction layer, and a second current collecting layer, the method comprising:
forming the first reaction layer by repeatedly applying a reaction-layer-forming material on the first current-collecting layer at predetermined intervals.

2. A method of manufacturing a fuel cell, comprising:.
on a first substrate, forming first gas passages to supply first reaction gas;
forming a first current collecting layer to collect electrons generated by a reaction of the first reaction gas supplied through the first gas passages;
forming a first reaction layer to cause the first reaction gas supplied through the first gas passages to react with a catalyst;
forming an electrolyte membrane;
on a second substrate, forming second gas passages to supply second reaction gas;
forming a second current collecting layer to collect electrons which are subjected to a reaction with the second reaction gas supplied through the second gas passages; and
forming a second reaction layer to cause the second reaction gas supplied through the second gas passages to react with a catalyst,
at least one of forming the first reaction layer and forming the second reaction layer forming the first reaction layer or the second reaction layer by repeatedly applying a reaction-layer-forming material on the first current collecting layer or the second current collecting layer at predetermined intervals.

3. The method of manufacturing a fuel cell according to claim 1,
a discharging device is employed to apply the reaction-layer-forming material.

4. The method of manufacturing a fuel cell according to claim 1,
the first reaction layer being formed by removing unnecessary components from a film, which is obtained by applying the reaction-layer-forming material, under reduced pressure and at a temperature no greater than 100° C.

5. The method of manufacturing a fuel cell according to claim 1,
the first reaction layer being formed by repeating a unit operation in which a given amount of the reaction-layer-forming material is applied on the entire area of a first reaction layer forming region on the first current collecting layer at predetermined intervals and unnecessary components are removed from droplets of the applied reaction-layer-forming material.

6. The method of manufacturing a fuel cell according to claim 5,
the discharging device being provided with a plurality of discharging nozzles, and the reaction-layer-forming material being discharged and applied during every unit operation by a different discharging nozzle.

7. An electronic apparatus, comprising:
a fuel cell manufactured by a method according to claim 1 as a power supply.

8. An automobile, comprising:
a fuel cell manufactured by a method according to claim 1 as a power supply.
